(19) United States
(12) Patent Application Publication
(10) Pub. No.: US 2012/0162546 A1
(43) Pub. Date: Jun. 28, 2012

(54) TELEVISION AND ELECTRONIC APPARATUS

(75) Inventor: Tsuyoshi Shimomichi, Fuchu-shi (JP)

(73) Assignee: KABUSHIKI KAISHA TOSHIBA, Tokyo (JP)

(21) Appl. No.: 13/279,106

(22) Filed: Oct. 21, 2011

(30) Foreign Application Priority Data
Dec. 27, 2010 (JP) 2010291000

(51) Int. Cl. H04N 5/64; H04N 3/14; G02F 1/13357

(52) U.S. Cl. 348/794; 349/64; 348/790; 348/E03.016; 348/E05.128

(57) ABSTRACT

According to one embodiment, an electronic apparatus includes a rectangular liquid crystal panel, a light-guide plate, a light bar corresponding a short side of the liquid crystal panel and including a plurality of light-emitting diodes, a reflector on the light-guide plate, a prism sheet on the light-guide plate on a side opposite to the reflector, and a polarizing sheet on the prism sheet configured to diffuse light.

### CROSS-REFERENCE TO RELATED APPLICATIONS

This application is based upon and claims the benefit of priority from prior Japanese Patent Application No. 2010-291000, filed Dec. 27, 2010, the entire contents of which are incorporated herein by reference.

### FIELD

Embodiments described herein relate generally to a television and an electronic apparatus.

### BACKGROUND

Some electronic apparatuses include a liquid crystal panel, a light-guide plate, and a light bar.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary front view of a television according to one embodiment;

FIG. 2 is an exemplary side view of the television illustrated in FIG. 1;

FIG. 3 is an exemplary exploded perspective view schematically illustrating a configuration of the television illustrated in FIG. 1;

FIG. 4 is an exemplary cross-sectional view of the television taken along the line F4-F4 in FIG. 1;

FIG. 5 is an exemplary perspective view of a light bar illustrated in FIG. 4;

FIG. 6 is an exemplary plan view of the light bar illustrated in FIG. 4;

FIG. 7 is an exemplary view schematically illustrating wiring patterns of the light bar illustrated in FIG. 4;

FIG. 8 is an exemplary view schematically illustrating an example of the operation of the light bar illustrated in FIG. 4;

FIG. 9 is an exemplary view schematically illustrating another example of the operation of the light bar illustrated in FIG. 4; and

FIG. 10 is an exemplary cross-sectional view of the light bar taken along the line F10-F10 in FIG. 6.

### DETAILED DESCRIPTION

Various embodiments will be described hereinafter with reference to the accompanying drawings.

In general, according to one embodiment, an electronic apparatus comprises a rectangular liquid crystal panel, a light-guide plate, a light bar corresponding a short side of the liquid crystal panel and comprising a plurality of light-emitting diodes, a reflector on the light-guide plate, a prism sheet on the light-guide plate on a side opposite to the reflector, and a polarizing sheet on the prism sheet configured to diffuse light.

Hereinafter, embodiments will be described with reference to the drawings.

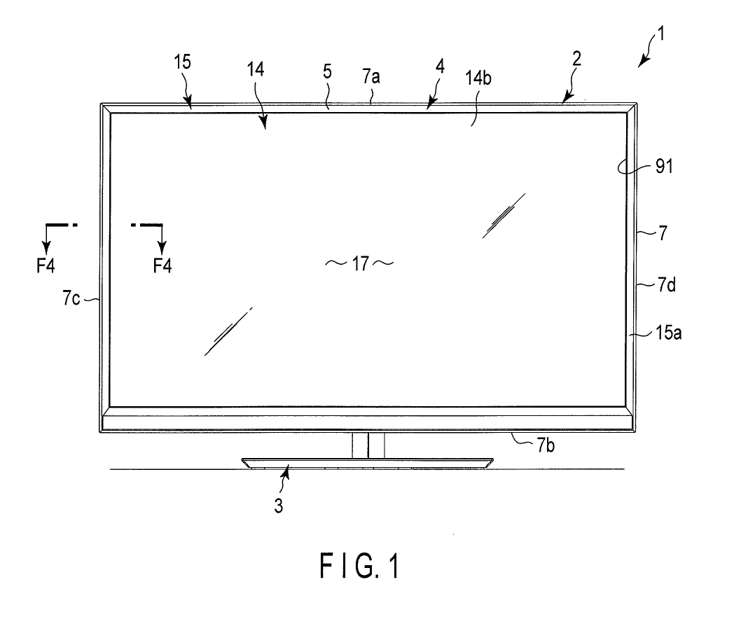

FIGS. 1 to 10 disclose a television 1 according one embodiment. The television 1 is an example of an electronic apparatus. The electronic apparatus, to which the present embodiment can be applied, is not limited to the television, but the present embodiment can be broadly applied to various electronic apparatuses, such as a notebook personal computer, a cellular phone, a smart phone, a personal digital assistant (PDA), and a game machine.

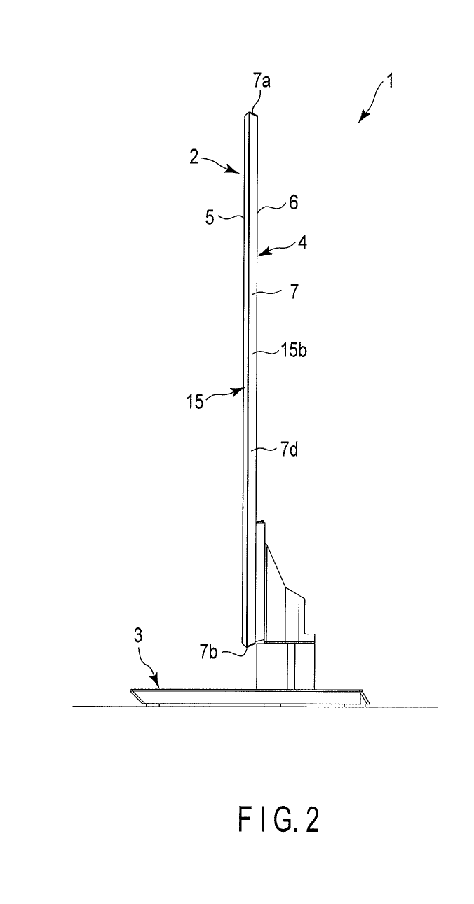

As illustrated in FIGS. 1 and 2, the television 1 includes a display unit 2 and a stand 3. The stand 3 is placed on a television table, for example. The display unit 2 is formed in a flat shape and supported by the stand 3 in a state of standing substantially vertically.

The display unit 2 includes a housing 4. The housing 4 includes a front wall 5, a back wall 6, and a circumferential wall 7. The front wall 5 stands substantially vertically and faces users. The back wall 6 is disposed on a side opposite to the front wall 5 and stands substantially vertically to be substantially parallel to the front wall 5. The circumferential wall 7 connects the peripheral portion of the front wall 5 and the peripheral portion of the back wall 6.

The circumferential wall 7 includes an upper wall 7a, a lower wall 7b, a left side wall 7c (first side wall), and a right side wall 7d (second side wall). The upper and lower walls 7a and 7b extend substantially horizontally. The left and right side walls 7c and 7d extend substantially vertically. In this way, the housing 4 having a flat rectangular shape is formed.

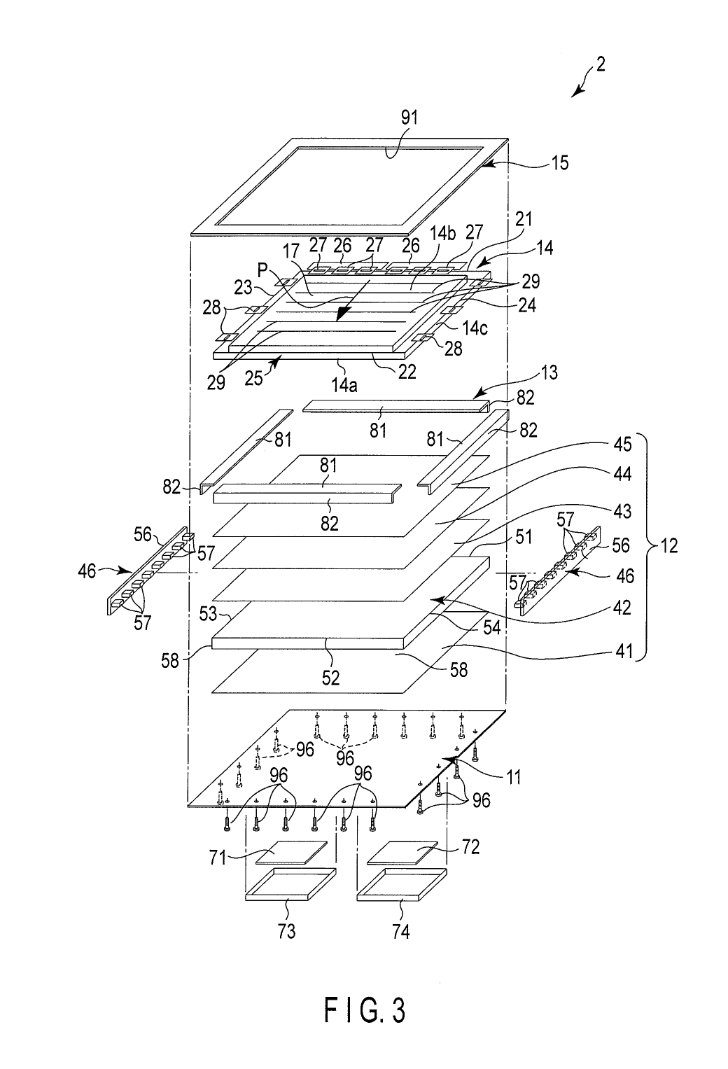

As illustrated in FIG. 3, the television 1 includes a back cover 11, a backlight unit 12, a middle frame 13, a liquid crystal panel 14, and a front cover 15. The back cover 11 is an example of a “first cover.” The front cover 15 is an example of a “second cover.” The middle frame 13 is an example of a “metal frame.” The liquid crystal panel 14 is an example of a “panel.” The “panel” may be any panel other than the liquid crystal panel.

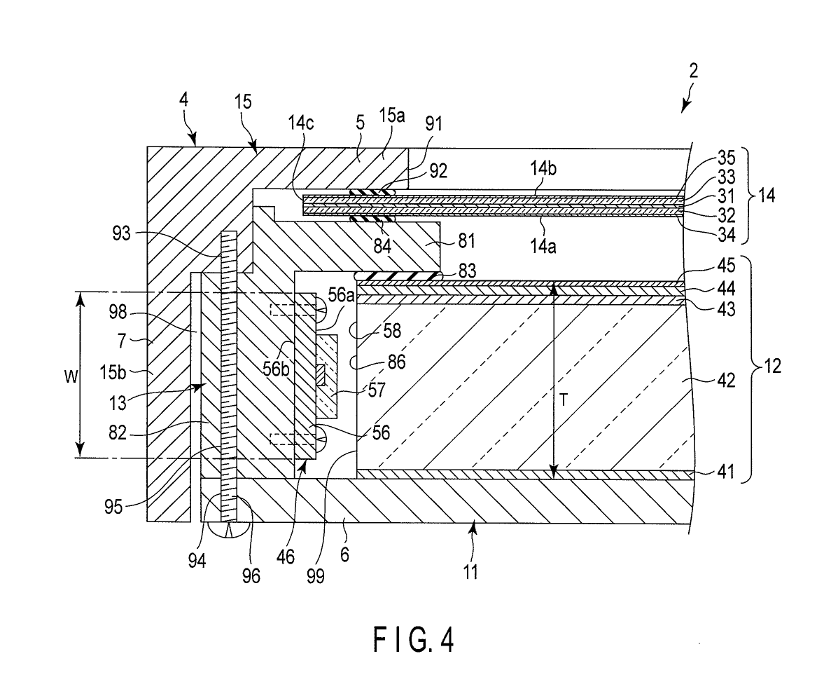

As illustrated in FIGS. 3 and 4, the liquid crystal panel 14 includes a back surface 14a, a front surface 14b, and a circumferential surface 14c. The back surface 14a is an example of a “first surface.” The front surface 14b is an example of a “second surface.” The front surface 14b is disposed on a side opposite to the back surface 14a and includes a display screen 17. The circumferential surface 14c is an example of a “third surface.” The circumferential surface 14c is positioned between the back surface 14a and the front surface 14b.

The liquid crystal panel 14 is formed in a rectangular shape having four sides 21, 22, 23, and 24. The four sides 21, 22, 23, and 24 include two long sides 21 and 22 and two short sides 23 and 24. As illustrated in FIG. 1, the liquid crystal panel 14 is accommodated in the housing 4 with the two long sides 21 and 22 oriented substantially horizontally. The two long sides 21 and 22 include a first long side 21 which is the upper long side and a second long side 22 which is the lower long side.

As illustrated in FIG. 3, the liquid crystal panel 14 includes a panel unit 25, and a source board 26 and driver ICs 27 and 28 which are attached to the panel unit 25. The driver IC 27 is a source chip-on-film (COF). The driver IC 28 is a gate COF.

As illustrated in FIG. 3, the liquid crystal panel 14 of the present embodiment includes scanning lines 29 which are arranged in a direction from the first long side 21 to the second long side 22. Arrow P in FIG. 3 indicates the direction of progress of writing of images on the liquid crystal panel 14. In the liquid crystal panel 14, images are written to the scanning lines 29 in the order from the first long side 21 to the second long side 22. In this way, in the liquid crystal panel 14, writing of images progresses in the direction from the first long side 21 toward the second long side 22.

As illustrated in FIG. 4, the panel unit 25 includes a liquid crystal layer 31, two glass plates 32 and 33, and two polarizing plates 34 and 35 (polarization filters). The liquid crystal layer 31 is interposed between the two glass plates 32 and 33. Moreover, the two glass plates 32 and 33 are interposed between the two polarizing plates 34 and 35. In this way, the two polarizing plates 34 and 35 are at the outermost side of the liquid crystal panel 14 and are exposed to the outside. The polarizing plate 35 is positioned on the front surface 14b of the liquid crystal panel 14 so as to face the front cover 15.

As illustrated in FIG. 3, the backlight unit 12 faces the back surface 14a of the liquid crystal panel 14. The backlight unit 12 includes a reflector (reflective sheet) 41, a light-guide plate 42, first and second prism sheets 43 and 44, a polarizing sheet 45, and a pair of light bars 46.

The reflector 41 is stacked on the back surface of the light-guide plate 42. The first prism sheet 43 is stacked on the light-guide plate 42 from a side opposite to the reflector 41. The second prism sheet 44 is stacked on the first prism sheet 43. The polarizing sheet 45 is stacked on the second prism sheet 44. In other words, the second prism sheet 44 is inserted between the first prism sheet 43 and the polarizing sheet 45. The first prism sheet 43 is a horizontal prism sheet, for example, and the second prism sheet 44 is a vertical prism sheet 44, for example. The polarizing sheet 45 has a light diffusing function.

The light-guide plate 42 has a substantially rectangular shape corresponding to the liquid crystal panel 14. That is, the light-guide plate 42 has two long sides 51 and 52 and two short sides 53 and 54. The long sides 51 and 52 the light-guide plate 42 extend along the long sides 21 and 22 of the liquid crystal panel 14. The short sides 53 and 54 of the light-guide plate 42 extend along the short sides 23 and 24 of the liquid crystal panel 14.

As illustrated in FIG. 5, the light bars 46 include an elongated circuit board 56 and a plurality of LEDs (light-emitting diodes) 57 mounted on the surface of the circuit board 56 and serve as a light source of the backlight unit 12. The plurality of LEDs 57 are arranged in a line along the longitudinal direction of the circuit board 56.

As illustrated in FIG. 3, the pair of light bars 46 is disposed on the left and right sides of the light-guide plate 42 so as to correspond to the two short sides 23 and 24 of the liquid crystal panel 14. That is, the pair of light bars 46 is disposed along the two short sides 53 and 54 (left and right ends) of the light-guide plate 42 so as to extend in the direction of progress of writing of images on the liquid crystal panel 14. The plurality of LEDs 57 are arranged in the direction of progress of writing of images on the liquid crystal panel 14. The “direction of progress of writing of images on the liquid crystal panel” is the “arrangement direction of the scanning lines on the liquid crystal panel.”

As illustrated in FIG. 4, the light-guide plate 42 includes side surfaces 58 extending along the short sides 53 and 54. The circuit board 56 includes a first board surface 56a (first surface) on which the plurality of LEDs 57 are mounted and a second board surface 56b (second surface) opposite to the first board surface 56a.

The circuit board 56 is disposed to be bent in a posture substantially vertical to the reflector 41, and the first board surface 56a faces the side surface 58 of the light-guide plate 42. That is, the circuit board 56 is substantially parallel to the side surface 58 of the light-guide plate 42, and a plurality of LEDs 57 face the side surface 58 of the light-guide plate 42. The width W in the lateral direction of the circuit board 56 is smaller than the thickness T of the backlight unit 12.

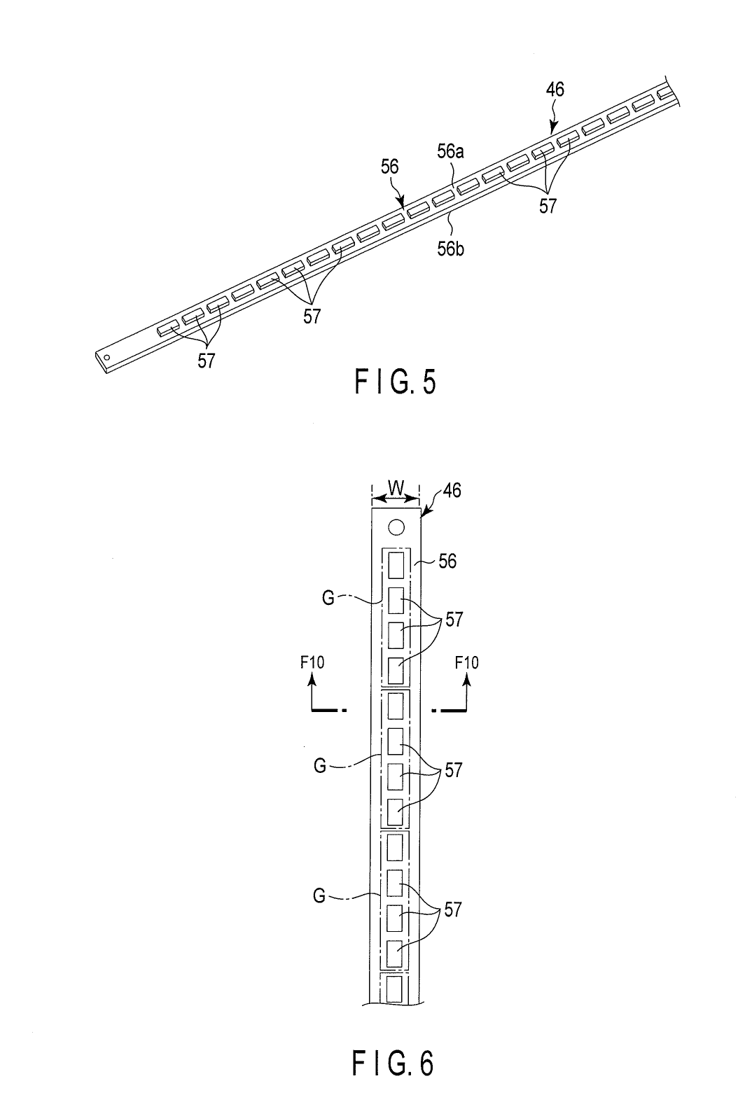

As illustrated in FIG. 6, the plurality of LEDs 57 are divided into a plurality of groups G in the direction of progress of writing of images on the liquid crystal panel 14. As an example, each of the light bars 46 includes 84 LEDs 57, and the 84 LEDs 57 are divided into 16 groups G each including four LEDs.

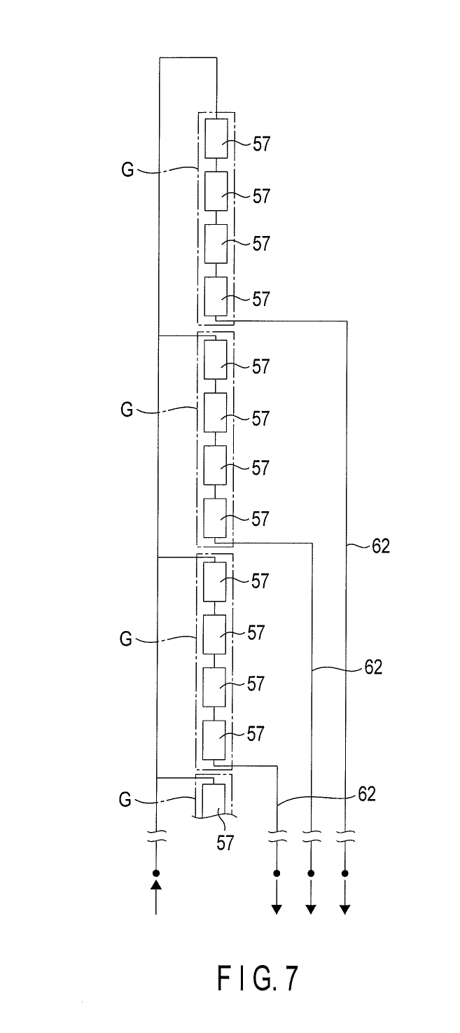

As illustrated in FIG. 7, wiring patterns (electrical interconnections) 62 are individually connected to the groups G of the plurality of LEDs 57, respectively. That is, in the light bar 46 divided into 16 groups G, at least 16 wiring patterns 62 are provided. In this way, the plurality of LEDs 57 can be independently turned on or off by a group G. The LEDs 57 of the respective groups G are turned on or off by a group G in synchronization with the progression of the writing of images on the liquid crystal panel 14.

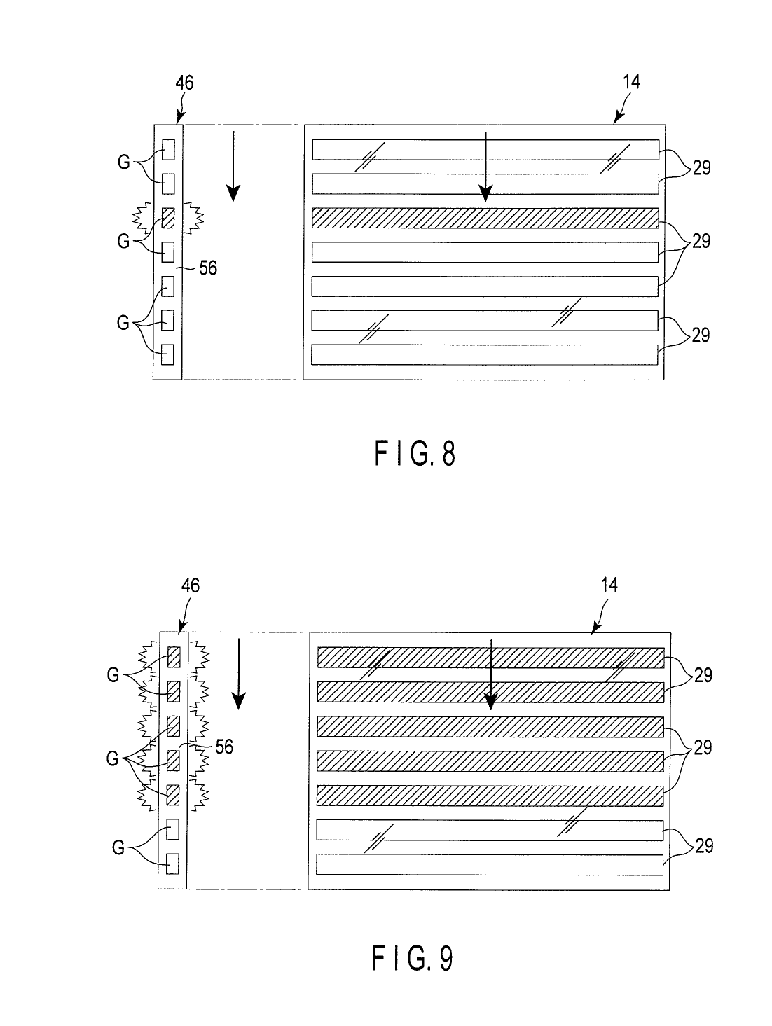

FIG. 8 schematically illustrates an example of the operation of the light bar 46. The LEDs 57 of the respective groups G are associated with the scanning lines 29 adjacent to the corresponding groups G, for example. The LEDs 57 of the corresponding groups G are turned on in synchronization with the time when images are written to the associated scanning lines 29, respectively. That is, the LEDs 57 are sequentially turned on by a group G in synchronization with the progress of the writing of images on the liquid crystal panel 14. In other words, the emission line of the backlight follows the writing of images on the liquid crystal panel 14. At this time, the LEDs 57 of the other groups G are turned off, for example. According to such an operation, it is possible to decrease residual images.

FIG. 9 schematically illustrates another example of an operation of the light bar 46. In the example illustrated in FIG. 9, the LEDs 57 of one or plural groups G are turned off in synchronization with the progression of writing of images on the liquid crystal panel 14. That is, a part of the backlight is turned off at the same time as the writing of images is provided in a part of one image frame, so that it is possible to decrease residual images.

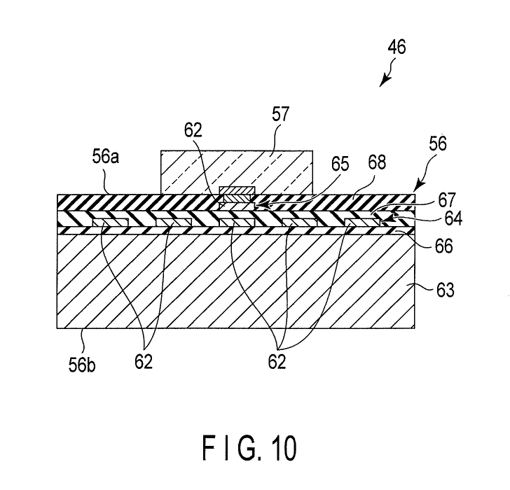

As illustrated in FIG. 10, the circuit board 56 includes a metal base 63, a plurality of conductor layers 64 and 65 formed on the metal base 63, and insulating layers 66, 67, and 68 formed between them. An example of the metal base 63 is an aluminum alloy. The wiring patterns 62 connected to the groups G, respectively are wired to be divided into the plurality of conductor layers 64 and 65.

Next, a mounting structure of the light bar 46 will be described.

As illustrated in FIGS. 3 and 4, the back cover 11 has a larger size than the liquid crystal panel 14 and the backlight unit 12. The back cover 11 is formed of metal such as, for example, an aluminum alloy. The back cover 11 is provided on the back surface side of the backlight unit 12, is exposed to the outside and forms the back wall 6 of the housing 4.

The back cover 11 covers the backlight unit 12. More specifically, the back cover 11 covers the back surface 14a of the liquid crystal panel 14 with the backlight unit 12 disposed therebetween. As illustrated in FIG. 3, a controller board 71, an LED driver board 72, and shield casings 73 and 74 are mounted on the back surface of the back cover 11. The shield casings 73 and 74 cover the boards 71 and 72, respectively. The LED driver board 72 is an example of a “controller” that controls the light bar 46.

As illustrated in FIGS. 3 and 4, the middle frame 13 is interposed between the liquid crystal panel 14 and the backlight unit 12 and faces the side surface 58 of the light-guide plate 42. The middle frame 13 is formed separately from the back cover 11 and the front cover 15. The middle frame 13 is formed of metal such as an aluminum alloy. The middle frame 13 is formed to be divided into four parts which correspond to the four sides 51, 52, 53, and 54 of the light-guide plate 42, respectively, for example. The middle frame 13 may be an integrated member having a frame shape.

As illustrated in FIG. 4, the middle frame 13 includes a supporting portion 81 (first portion) and a fixing portion 82 (second portion). The supporting portion 81 is interposed between the liquid crystal panel 14 and the backlight unit 12. An elastic member 83 such as rubber is provided between the supporting portion 81 and the backlight unit 12. The supporting portion 81 presses the backlight unit 12 toward the back cover 11. In this way, the backlight unit 12 is held between the back cover 11 and the middle frame 13.

Furthermore, the liquid crystal panel 14 is placed on the supporting portion 81 of the middle frame 13. An elastic member 84 such as rubber is provided between the supporting portion 81 and the liquid crystal panel 14. The supporting portion 81 supports the liquid crystal panel 14 with the elastic member 84 disposed therebetween.

The fixing portion 82 is provided at a position not in between the liquid crystal panel 14 and the backlight unit 12. The fixing portion 82 faces the side surface 86 of the backlight unit 12. The fixing portion 82 has a size corresponding to the distance between the back cover 11 and the front cover 15 and is sandwiched between the back cover 11 and the front cover 15. In this way, the middle frame 13 is held between the back cover 11 and the front cover 15.

As illustrated in FIG. 4, the light bars 46 are attached to the middle frame 13 so as to face the side surface 58 of the light-guide plate 42. Specifically, the circuit board 56 of each of the light bars 46 is fixed, for example, by means of a screw, to the fixing portion 82 of the middle frame 13. In this way, the light bars 46 are thermally connected to the middle frame 13. That is, part of the heat generated by the light bars 46 is transferred to the middle frame 13.

As illustrated in FIG. 3, the front cover 15 has a larger size than the liquid crystal panel 14 and the backlight unit 12. The front cover 15 is formed of metal such as, for example, an aluminum alloy. The front cover 15 is provided on the front surface side of the liquid crystal panel 14 and is connected to the back cover 11 to form the front wall 5 and the circumferential wall 7 of the housing 4. The front cover 15 includes an opening 91, through which the display screen 17 of the liquid crystal panel 14 is exposed, and is formed in a frame shape covering the periphery of the liquid crystal panel 14. The front cover 15 is an example of an exterior member and is exposed to the outside of the television 1 to form a part of the external appearance of the television 1.

As illustrated in FIG. 4, the front cover 15 directly faces the polarizing plate 35 of the liquid crystal panel 14. An elastic member 92 such as rubber is provided between the front cover 15 and the polarizing plate 35. The front cover 15 supports the polarizing plate 35 with the elastic member 92 disposed therebetween. In this way, the liquid crystal panel 14 is held between the front cover 15 and the middle frame 13.

As illustrated in FIG. 4, the front cover 15 includes a threaded screw hole 93. The back cover 11 and the middle frame 13 include insertion holes 94 and 95, respectively, which correspond to the screw hole 93 of the front cover 15. A screw 96 is inserted through the insertion hole 94 of the back cover 11 and the insertion hole 95 of the middle frame 13 so as to engage with the screw hole 93. In this way, the back cover 11, the middle frame 13, and the front cover 15 are fastened by the screw 96.

The fixing portion 82 of the middle frame 13 is thermally connected to the back cover 11 and the front cover 15 which are formed of metal. In this way, part of the heat transferred from the light bars 46 to the middle frame 13 is transferred to the back cover 11 and the front cover 15 and dissipated to the outside of the television 1. The screw 96 which fastens the back cover 11, the middle frame 13, and the front cover 15 constitutes a part of a heat conduction path that thermally connects the back cover 11, the middle frame 13, and the front cover 15.

As illustrated in FIGS. 4 and 5, the front cover 15 includes a first portion 15a that faces the front surface 14b of the liquid crystal panel 14 and a second portion 15b that is bent upward from the peripheral portion of the first portion 15a so as to extend backward. The second portion 15b has a size corresponding to substantially the whole thickness of the display unit 2. The front cover 15 surrounds the circumferential surface 14c of the liquid crystal panel 14, a circumferential surface 98 of the middle frame 13, and a circumferential surface 99 of the backlight unit 12. That is, the first portion 15a of the front cover 15 forms the front wall 5 of the housing 4. Furthermore, the second portion 15b of the front cover 15 forms the circumferential wall 7 of the housing 4.

According to such a configuration, it is possible to obtain a structure suitable for obtaining high-quality images. That is, the television 1 of the present embodiment includes the rectangular liquid crystal panel 14, the light bar 46 which is provided on the lateral side of the light-guide plate 42 so as to extend along the short side 23 or 24 of the liquid crystal panel 14 and which includes a plurality of LEDs 57, the reflector 41 stacked on the light-guide plate 42, the prism sheet 43 stacked on the light-guide plate 42 from a side opposite to the reflector 41, and the polarizing sheet 45 stacked on the prism sheet 43 and having a light diffusing function.

According to this configuration, the light bar 46 is disposed along the short side 23 or 24 of the liquid crystal panel 14. When the light bar 46 is disposed along the short side 23 or 24 of the liquid crystal panel 14, and writing of images progress in the lateral direction of the liquid crystal panel 14, it is possible to control the turning on/off of the LEDs 57 in accordance with the writing of images. In this way, it is possible to obtain high-quality images.

In the present embodiment, the plurality of LEDs 57 are divided into a plurality of groups G in the direction of progress of writing of images on the liquid crystal panel 14, and the LEDs 57 of the respective groups G are turned on or off in synchronization with the progression of the writing of images on the liquid crystal panel 14. With this configuration, it is possible to turn on or off a partial region of the backlight unit 12 in synchronization with the writing of images on the liquid crystal panel 14. Thus, it is possible to obtain higher-quality images, for example, in such a way that the occurrence of residual images can be decreased.

Here, when the light bar 46 is disposed along the short sides 53 and 54 of the light-guide plate 42, the entire length of the light bar 46 will decrease as compared to when the light bar 46 is disposed along the long sides 51 and 52 of the light-guide plate 42. As a result, there is a possibility that the number of LEDs 57 that can be mounted on the light bar 46 decreases, and the luminance of the light bar 46 decreases.

Therefore, in the present embodiment, the second prism sheet 44 is provided between the first prism sheet 43 and the polarizing sheet 45. With this configuration, it is possible to suppress a decrease in the luminance even when the number of LEDs 57 decreases.

Furthermore, using a polarizing sheet 45 having a light diffusing function allows omission of a diffusion sheet disposed between the light-guide plate 42 and the first prism sheet 43. In this way, it is possible to decrease the thickness of the backlight unit 12 by an amount corresponding to at least the thickness of the diffusion sheet. Thus, it is possible to suppress an increase in the thickness of the backlight unit 12 resulting from the second prism sheet 44.

In the present embodiment, the plurality of LEDs 57 are divided into 16 groups G, for example, and at least 16 wiring patterns 62 connected to these groups are necessary. Moreover, it is necessary to lay out the 16 wiring patterns 62 within the elongated circuit board 56 having a limited mounting area.

In the present embodiment, the circuit board 56 of the light bar 46 includes the metal base 63 and the plurality of conductor layers 64 and 65 formed on the metal base 63. Moreover, the wiring patterns 62 connected to the groups G are wired to be divided into the plurality of conductor layers 64 and 65. With this configuration, the plurality of wiring patterns 62 can be wired within a relatively small mounting area without causing the plurality of wiring patterns 62 to interfere with each other.

In the present embodiment, the circuit board 56 includes the board surface 56a on which the plurality of LEDs 57 are mounted and is disposed to be bent in a posture substantially vertical to the reflector 41, and the board surface 56a faces the side surface 58 of the light-guide plate 42. According to such a configuration, the light from the LEDs 57 can be radiated toward the light-guide plate 42 without a large loss as compared to when the circuit board 56 is disposed to be substantially parallel to the reflector 41.

In the present embodiment, the width W in the lateral direction of the circuit board 56 is smaller than the thickness T of the backlight unit 12. According to this configuration, the circuit board 56 can be disposed to extend along the side surface 86 of the backlight unit 12 while suppressing the thickness of the television 1.

As described above, when the light bar 46 is disposed along the short sides 53 and 54 of the light-guide plate 42, the entire length of the light bar 46 will decrease as compared to when the light bar 46 is disposed along the long side 51 or 52 of the light-guide plate 42. As a result, there is a possibility that the gap between the LEDs 57 mounted on the light bar 46 decreases, and thermal density increases due to the LEDs 57 arranged at a small pitch.

Therefore, in the present embodiment, the television 1 includes the middle frame 13 which is formed of metal and faces the side surface 58 of the light-guide plate 42, and the light bar 46 is thermally connected to the middle frame 13. With this configuration, since the middle frame 13 functions as a heat sink that dissipates part of the heat generated by the light bars 46, it is possible to suppress an increase in the thermal density of the light bar 46 and to omit, or decrease the size of, a heat sink provided exclusively for the light bars 46. This contributes to decreasing the thickness of the television 1.

In the present embodiment, the television 1 includes the back cover 11 which covers the backlight unit 12 and is exposed to the outside. The middle frame 13 includes the supporting portion 81 holding the backlight unit 12 between the middle frame 13 and the back cover 11, and the fixing portion 82 facing the side surfaces 86 of the backlight unit 12. The light bar 46 is attached to the fixing portion 82 of the middle frame 13. That is, in the present embodiment, the light bar 46 is mounted using the middle frame 13 holding the backlight unit 12. According to this configuration, the number of members necessary for fixing and holding the light bar 46 can be decreased. This contributes to decreasing the thickness and cost of the television 1.

In the present embodiment, the middle frame 13 is thermally connected to the back cover 11 made of metal. With this configuration, part of the heat generated by the light bar 46 is dissipated to the outside of the television 1 from the back cover 11. With this configuration, the heat dissipation structure of the light bar 46 can be simplified.

Furthermore, in the present embodiment, the television 1 includes the front cover 15 which is formed of metal and exposed to the outside and which holds the liquid crystal panel 14 between the front cover 15 and the middle frame 13. The middle frame 13 is thermally connected to the front cover 15. With this configuration, part of the heat generated by the light bar 46 is dissipated to the outside of the television 1 from the front cover 15. With this configuration, the heat dissipation structure of the light bar 46 can be simplified.

The liquid crystal panel 14 is vulnerable to heat, and for example, when it is heated in partial areas, images may appear differently in those areas. In the present embodiment, the elastic member 84 is provided between the middle frame 13 and the liquid crystal panel 14, so that a gap is formed between the middle frame 13 and the liquid crystal panel 14. The elastic member 84 makes the heat hard to be transferred from the middle frame 13 to the liquid crystal panel 14.

When the polarizing plates 34 and 35 of the liquid crystal panel 14 are expanded thermally too much, the function of the polarizing plate deteriorates. In the present embodiment, the elastic member 84 makes the heat hard to be transferred from the middle frame 13 to the polarizing plate 34. Similarly, the elastic member 83 makes the heat hard to be transferred from the middle frame 13 to the backlight unit 12. Furthermore, the elastic member 92 makes the heat hard to be transferred from the front cover 15 to the polarizing plate 35 of the liquid crystal panel 14.

The embodiment is not limited to the embodiment described above but may be realized by modifying constituent elements in the implementing stage within a range without departing from the spirit of the invention. Moreover, various embodiments can be made by appropriately combining a plurality of constituent elements disclosed in the above-described embodiments. For example, some constituent elements may be omitted from all the constituent elements disclosed in the embodiments. Furthermore, constituent elements in different embodiments may be combined appropriately.

The metal frame (middle frame 13) may be integrated with any one of a first metal cover (back cover 11) and a second metal cover (front cover 15). The middle frame 13 can accelerate dissipation of heat as long as at least a portion where the light bar 46 is mounted is formed of metal, in which case the other portions may be formed of materials other than metal. Moreover, the whole middle frame 13 may be formed of materials other than metal. The shape of the middle frame 13 and the fixing structure thereof are not limited to those described above. The back cover 11 and the front cover 15 may not be formed of metal.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A television comprising:
a rectangular liquid crystal panel configured to allow writing of images to progress from a first long side toward a second long side of the liquid crystal panel;
a rectangular light-guide plate;
a pair of light bars along short sides of the light-guide plate, respectively, extending in the direction of progress of writing of images, each of the light bars comprising a circuit board and a plurality of light-emitting diodes arranged in the direction of progress of writing of images;
a reflector on the light-guide plate;
a prism sheet on the light-guide plate on a side opposite the reflector; and
a polarizing sheet on the prism sheet,
wherein the plurality of light-emitting diodes are divided into a plurality of groups in the direction of progress of writing of images, the circuit board comprises electrical interconnections individually connected to the groups, respectively, and each of the groups are configured to light in synchronization with the progression of the writing of images, and
the circuit board comprises a metal base and a plurality of conductor layers, and the electrical interconnections are divided into the plurality of conductor layers.

2. The television of claim 1,
wherein the circuit board comprises a surface configured to support at least some of the plurality of light-emitting diodes, the surface being configured to face a side surface of the light-guide plate.

3. The television of claim 2, further comprising:
a backlight unit comprising the light-guide plate, the reflector, the prism sheet, and the polarizing sheet,
wherein a width in a lateral direction of the circuit board is smaller than a thickness of the backlight unit.

4. The television of claim 3, further comprising:
a metal frame configured to face the side surface of the light-guide plate,
wherein at least one of the light bars is configured to be attached to the metal frame and thermally connected to the metal frame.

5. The television of claim 4, further comprising:
a back cover configured to cover the backlight unit and be outwardly exposed,
wherein the metal frame comprises a first portion configured to hold the backlight unit between the metal frame and the back cover, and a second portion configured to face a side surface of the backlight unit, and
at least one of the light bars is configured to be attached to the second portion of the metal frame.

6. The television of claim 5,
wherein the back cover is metallic, and
the metal frame is configured to be thermally connected to the back cover.

7. The television of claim 6, further comprising:
a metal front cover configured to cover an edge portion of the liquid crystal panel, be exposed to the outside of the television, hold the liquid crystal panel between the metal frame and the front cover, and be thermally connected the metal frame.

8. An electronic apparatus comprising:
a rectangular liquid crystal panel;
a light-guide plate;
a light bar corresponding to a short side of the liquid crystal panel and comprising a plurality of light-emitting diodes;
a reflector on the light-guide plate;
a prism sheet on the light-guide plate on a side opposite to the reflector; and
a polarizing sheet on the prism sheet configured to diffuse light.

9. The electronic apparatus of claim 8,
wherein, the liquid crystal panel is configured to allow writing of images to progress from a first long side toward a second long side of the liquid crystal panel, and
the plurality of light-emitting diodes are arranged in the direction of progress of writing of images.

10. The electronic apparatus of claim 9,
wherein the plurality of light-emitting diodes are divided into a plurality of groups in the direction of progress of writing of images, each of the groups being configured to light in synchronization with the progression of the writing of images.
